(19) United States
(12) Patent Application Publication
(10) Pub. No.: US 2024/0296312 A1
(43) Pub. Date: Sep. 5, 2024

(54) SYSTEMS AND METHODS FOR DETERMINING A COMBINATION OF SENSOR MODALITIES BASED ON ENVIRONMENTAL CONDITIONS

(71) Applicant: Caterpillar Inc., Peoria, IL (US)

(72) Inventors: Lawrence A. MIANZO, Pittsburgh, PA (US); Norman K. LAY, Baden, PA (US); Arthur MILKOWSKI, Oro Valley, AZ (US); Shawn N. MATHEW, Savoy, IL (US)

(73) Assignee: Caterpillar Inc., Peoria, IL (US)

(21) Appl. No.: 18/178,100

(22) Filed: Mar. 3, 2023

(51) Int. Cl. G06N 3/047; G01B 21/08

(52) U.S. Cl. CPC G06N 3/047; G01B 21/08

(57) ABSTRACT

A method for determining a wear or loss condition of a ground engaging tool (GET). The method includes receiving imaging data and environmental data from a plurality of sensors, the plurality of sensors includes a plurality of imaging sensors of different modalities. The method also includes determining network selection weights for each of a plurality of deep learning networks based on the imaging data or environmental data, wherein each of the plurality of deep learning networks utilizes a different respective combination of one or more of the plurality of imaging sensors as inputs. The method further includes determining at least one physical dimension of at least one portion of the GET using one or more of the plurality of deep learning networks based on the network selection weights. The wear or loss condition of the GET is determined based on the at least one physical dimension.

### TECHNICAL FIELD

The present disclosure relates generally to wear measurement systems, and more particularly, to a measurement platform that combines a plurality of sensors and algorithm modalities for detecting wear, damage, and/or loss of ground engaging tools (GETs).

### BACKGROUND

Ground-engaging implements (e.g., buckets) may be mounted to earth-working machines (e.g., excavators, continuous miners, loaders, etc.) that engage with and/or move a variety of earthen materials. The buckets may have GETs mounted to their edges, e.g., so that the GETs engage with the ground surfaces and/or earthen materials and thereby protect the edges of the bucket from wear and prolong the life of the bucket. Though GETs are generally formed of extremely hard and wear-resistant materials, repeated contact with hard ground surfaces and/or earthen materials may cause wear and damage (e.g., breakage) to GETs. Furthermore, partial or complete separation (e.g., loss) of GETs from the work implements can incur significant costs and downtime. For example, a bucket may be damaged due to the absence of the GET, and may significantly impact overall productivity and may potentially require costly repairs.

While monitoring systems can assist in determining wear and loss of GETs, these systems may not be able to adapt to changing environmental conditions at a worksite. In one instance, an RGB imager sensor may provide color cues and high-resolution dense images but may struggle with low lighting and/or dusty conditions. In another instance, a stereo (depth) camera may provide three-dimensional (3D) depth information but may struggle during low lighting and/or environmental obscurants. In a further instance, a long wave IR camera sensor may function properly during low lighting or no lighting but may struggle due to saturation or poor contrast in certain environmental conditions.

U.S. Pat. No. 10,339,667 B2, issued on Jul. 2, 2019 (“the '667 patent”), discloses a method for capturing an image of an operating implement, selecting successive pixel subsets within a plurality of pixels of the captured image, and processing the pixel subset to determine whether pixel intensity values indicate a likelihood that the pixel subset corresponds to the wear part. However, this approach may require good environmental conditions (e.g., good lighting, good weather, etc.) to capture clear images of the operating implement. Further, the approach does not address the potential for false positives associated with detection failures due to environmental conditions (e.g., low lighting, bad weather, etc.).

The disclosed method and system may solve one or more of the problems set forth above and/or other problems in the art. The scope of the current disclosure, however, is defined by the attached claims, and not by the ability to solve any specific problem

### SUMMARY

According to certain aspects of the disclosure, methods and systems are disclosed for determining wear or loss condition of a ground engaging tool (GET).

In one aspect, a computer-implemented method for determining a wear or loss condition of a GET may include: receiving, by one or more processors, imaging data and environmental data from a plurality of sensors, wherein the plurality of sensors includes a plurality of imaging sensors of different modalities; determining, by the one or more processors, network selection weights for each of a plurality of deep learning networks based, at least in part, on one or more of the imaging data or the environmental data, wherein each of the plurality of deep learning networks utilizes a different respective combination of one or more of the plurality of imaging sensors as inputs; determining, by the one or more processors, at least one physical dimension of at least one portion of the GET using one or more of the plurality of deep learning networks based on the network selection weights; and determining, by the one or more processors, the wear or loss condition of the GET based on the at least one physical dimension.

In another aspect, a system for determining a wear or loss condition of a GET may include one or more processors, and at least one non-transitory computer readable medium storing instructions which, when executed by the one or more processors, cause the one or more processors to perform operations including: receiving imaging data and environmental data from a plurality of sensors, wherein the plurality of sensors includes a plurality of imaging sensors of different modalities; determining network selection weights for each of a plurality of deep learning networks based, at least in part, on one or more of the imaging data or the environmental data, wherein each of the plurality of deep learning networks utilizes a different respective combination of one or more of the plurality of imaging sensors as inputs; determining at least one physical dimension of at least one portion of the GET using one or more of the plurality of deep learning networks based on the network selection weights; and determining the wear or loss condition of the GET based on the at least one physical dimension.

In a further aspect, a non-transitory computer readable medium for determining a wear or loss condition of a GET, the non-transitory computer readable medium storing instructions which, when executed by one or more processors, cause the one or more processors to perform operations including: receiving imaging data and environmental data from a plurality of sensors, wherein the plurality of sensors includes a plurality of imaging sensors of different modalities; determining network selection weights for each of a plurality of deep learning networks based, at least in part, on one or more of the imaging data or the environmental data, wherein each of the plurality of deep learning networks utilizes a different respective combination of one or more of the plurality of imaging sensors as inputs; determining at least one physical dimension of at least one portion of the GET using one or more of the plurality of deep learning networks based on the network selection weights; and determining the wear or loss condition of the GET based on the at least one physical dimension.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic illustration of system 100 for determining a wear and/or loss condition of a GET, according to aspects of the disclosure.

FIG. 2 is a diagram of the components of the ground engaging tool (GET) monitoring platform, according to aspects of the disclosure.

FIG. 3 shows an exemplary machine learning training flow chart, according to aspects of the disclosure.

FIG. 4 illustrates an implementation of a computer system that executes techniques presented herein.

FIG. 5 is a flowchart of a process for determining wear and/or loss condition of a GET, according to some aspects of the disclosure.

FIG. 6A illustrates a network schematic for combining a plurality of deep learning networks that fuses various sensors of different modalities to determine wear and/or loss condition of a GET, according to some aspects of the disclosure.

FIG. 6B illustrates a network schematic for selecting a deep learning network from the plurality of deep learning networks to determine wear and/or loss condition of a GET, according to some aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

Conventional techniques for detecting wear and loss of the GETs include manual measurement or inspection of GETs. Such an approach may be not only time-consuming but also inaccurate. As discussed above, a sensor-based approach for detecting damages, wear, and/or loss of GETs may not account for environmental obscurants, and unclear images of the GETs may result in incorrect predictions (e.g., false positives). Such incorrect predictions may be associated with frequent false alarms, which can cause a worksite to repeatedly shut down when it is not necessary to do so and may reduce productivity. Thus, improvements to estimating wear and/or loss conditions of GETS would be beneficial. Presented herein is a method that takes into consideration environmental factors while selecting amongst deep learning networks utilizing sensors of different modalities for accurate prediction of damages, wear, and/or loss of GETs.

In an exemplary use case, a system for determining wear or loss of a GET may include imaging sensors of different modalities, e.g., RGB, depth, ultrasound, etc. The system may further include multiple deep learning networks, whereby each network is configured to use different combinations of the imaging sensors to estimate a wear or loss condition of the GET. The system (e.g., an environmental determination system), based on various factors indicative of the environment in which the GET is being used, may determine whether and to what extent each of the networks is to be used. For example, in low light conditions, one or more networks using an IR imaging sensor and/or a depth sensor may be used in favor of a network using an RGB imaging sensor. In some instances, only one network is used for a particular environmental condition. In some instances, estimates from different networks may be combined, e.g., weighted based on the confidence of the networks and/or a determination by the environment determination system of how well each network applies to the particular environmental conditions. The estimate of the wear or loss condition may be used as part of an operating condition status alert system, and output from the deep learning networks, e.g., segmentation of image data identifying locations of features of the GET, may be fed to a user interface display.

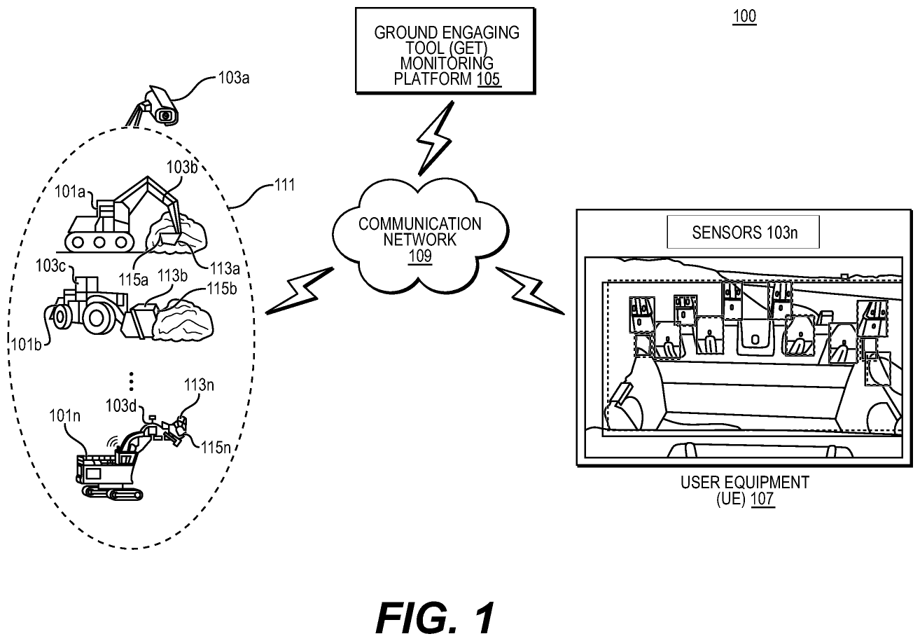

FIG. 1 is a schematic illustration of system 100 for determining a wear or loss condition of a GET, according to aspects of the disclosure. System 100 comprises machines 101a-101n (collectively referred to as machine 101), sensors 103a-103n (collectively referred to as sensor 103), GET monitoring platform 105, and user equipment (UE) 107. In one instance, GET monitoring platform 105 may have connectivity to machine 101, sensor 103, and/or UE 107 via communication network 109, e.g., a wireless communication network.

Machines 101 may include one or more earthmoving machines (e.g., a mining shovel, a loader, etc.), transportation or hauling machines (e.g., haul trucks), one or more processing machines (e.g., a conveyor and/or crushing machines), or other types of work-performing machines in worksite 111. In one instance, machines 101 may include ground-engaging implements 113a-113n (collectively referred to as implement 113) that are movable with one or more implement linkages (e.g., a hydraulically-movable boom and/or stick). Implement 113 (e.g., a bucket, ripper, blade, scraper, etc.) may be equipped with one or more GETs 115a-115n (collectively referred to as GET 115). GET 115 may include teeth and/or adapters, as well as other components attachable to implements 113 such as protectors for the sides or edges of the ground-engaging implement, including lip shrouds, side shrouds, and others. It is understood that machine 101 and other components of system 100 may include other types of machines and/or may perform tasks at a different type of worksite 111 (e.g., paving, construction, forestry, mining, etc.).

Although GET 115 are formed of extremely hard and wear-resistant materials to protect implement 113, GET 115 is still subject to severe abrasion and may need periodic repair or replacement. Repair and/or replacement of GET 115 may require disassembly of the GET 115 from implement 113, and then assembly of a repaired or a new GET 115 on implement 113. Machine 101 may be out of service to perform such replacement or repair. It is desirable to have a system that accurately determines the damages, wear, and loss of GET 115 for efficient repair, maintenance, or replacement of GET 115 at worksite 111 to allow machine 101 to be returned to service as quickly as possible.

Sensor 103 may include an image sensor (e.g., stereoscopic cameras, infrared cameras, optical cameras, or a plurality of these types of cameras) configured to capture image data of GET 115 and/or machine 101. In one instance, sensor 103 may be secured to implement linkage of machine 101 (e.g., a boom) to capture images and/or videos of GET 115. Sensors 103 may also be positioned on other parts of machine 101 or worksite 111 to capture images and/or videos of GET 115 that were not captured by the sensor positioned on the implement linkage due to material present in implement 113, or due to the position of implement 113. Sensor 103 is not limited to human-visible light or, in particular, to image or video, but may also include laser-based systems (LIDAR), or other types of systems that enable evaluation of terrain or material, measure the expected location of GETs, measure the dimensions of GETs, etc. By way of example, sensor 103 may further include any other type of sensor, for example, a weather sensor to detect environmental data, a depth sensor, a motion sensor, a tilt sensor, an orientation sensor, a light sensor, a network detection sensor for detecting wireless signals or receivers for different short-range communications (e.g., Bluetooth, Wi-Fi, Li-Fi, near field communication (NFC), etc.), a global positioning sensor for gathering location data, and the like. Any known and future implementations of sensor 103 may also be applicable.

GET monitoring platform 105 may be a platform with multiple interconnected components. GET monitoring platform 105 may include one or more servers, intelligent networking devices, computing devices, components, and corresponding software for determining damages, wear, and/or loss of GET 115. In addition, it is noted that GET monitoring platform 105 may be a separate entity of system 100 or a part of machine 101 or UE 107. Any known or still developing methods, techniques, or processes for determining the wear and/or loss condition of the GET may be employed by GET monitoring platform 105.

In one instance, GET monitoring platform 105 may receive imaging data, environmental data, and any other relevant data associated with GET 115 from sensor 103. GET monitoring platform 105 may combine and/or select between multiple deep learning networks that combine various sensors of different modalities, such as, in some environmental or lighting conditions. For example, long wave infrared (IR) camera may work better than a visible color (RGB) imager and a stereo camera (depth) during low lighting, but may not provide sufficient contrast in some conditions that the visible color (RGB) imager and the stereo camera (depth) may provide. Since useful information may be obtained from all of these sensors and/or from different combinations of sensors, GET monitoring platform 105, via deep learning networks, may utilize these sensors to provide estimations of the damage, wear, and/or loss condition of the GET 115. In one instance, the deep learning networks may include, for example, a convolutional neural network, a transformer or attention-based network, or any other suitable machine-learning model. The multiple deep-learning networks may, in various instances, be the same type of network or may include different types of networks.

In one instance, GET monitoring platform 105 may combine sensors utilized to detect GET 115 with other sensor information to determine a scene and/or environmental conditions. In one instance, sensors for detecting the GET are not used for determining environmental conditions. The determined scene and/or environmental conditions may be used to estimate the weight or contribution that is expected from each deep learning network under said conditions, e.g., whether each network is selected for use and to what extent the output of each network is relied on. The weights and a threshold may be applied to the predictions, e.g., identification and segmentation of the GET 115, from each deep learning network, and then the weighted results may be combined and normalized to provide an updated probability. Further, the normalized results may provide a combined bounding box and instance segmentation for each GET. Moreover, combining the probabilities and proximities of the bounding boxes and instance segmentation may lead to high probability prediction of the GET using multiple deep learning networks.

In one instance, instead of combining output from different deep learning networks, the determination of the environmental conditions may be used to select a best network for use with the environmental conditions.

In one instance, GET monitoring platform 105 may monitor or track, using visual and other data, the wear and/or loss condition of GET 115 of machine 101. GET monitoring platform 105 may enable functions including identifying potentially damaged (e.g., broken, heavily worn, etc.) or missing GET 115, confirming the damaged or missing GET 115, identifying a location within worksite 111 where the damaged or missing GET 115 of machine 101 may be present, controlling machine 101 present within worksite 111, and generating notifications confirming the damaged or missing GET 115 in a user interface of UE 107. GET monitoring platform 105 is discussed in further detail below. In an example, the GET monitoring platform 105 may include data relating to nominal operating conditions of the GET 115, e.g., size, position, thickness, etc., which may be compared with output from the deep learning network(s) to determine a current condition of the GET 115, e.g., a wear or loss condition.

UE 107 may include, but is not restricted to, any type of mobile terminal, wireless terminal, or portable terminal. Examples of UE 107, may include but are not restricted to, a mobile handset, a smartphone, a wireless communication device, a web camera, a laptop, a personal digital assistant (PDA), a computer integrated into the machine 101 such as a Heads-Up Display, a unit, a device, a multimedia computer, a multimedia tablet, an Internet node, a communicator, a Personal Communication System (PCS) device, a personal navigation device, a Personal Digital Assistant (PDA), a digital camera/camcorder, an infotainment system, or any combination thereof, including the accessories and peripherals of these devices, or any combination thereof. Any known and future implementations of UE 107 may also be applicable. In addition, UE 107 may include various applications such as, but not restricted to, camera/imaging applications, content provisioning applications, networking applications, multimedia applications, location-based applications, media player applications, and the like. In one instance, one of the applications at UE 107 may act as a client for GET monitoring platform 105 and may perform one or more functions of GET monitoring platform 105 by interacting with GET monitoring platform 105 over the communication network 109, e.g., via an Application Programming Interface (API). In one instance, UE 107 may facilitate various input/output means for receiving and generating information, including, but not restricted to, a display of a notification in a user interface of UE 107 pertaining to the status (e.g., wear or loss) of GET 115. In one instance, UE 107 may be a part of machine 101 to present a notification, such as an alert, to a supervisor, machine operator, or other users, to raise awareness of a potentially worn or missing GET 115.

Communication network 109 of system 100 may include one or more networks such as a data network, a wired or wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including 5G (5th Generation), 4G, 3G, 2G, Long Term Evolution (LTE), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

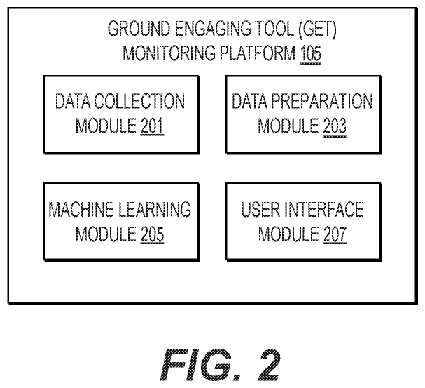

FIG. 2 is a diagram of the components of GET monitoring platform 105, according to aspects of the disclosure. As used herein, terms such as “component” or “module” generally encompass hardware and/or software, e.g., that a processor or the like is used to implement associated functionality. By way of example, GET monitoring platform 105 includes one or more components for determining the wear and/or loss condition of a GET. It is contemplated that the functions of these components are combined in one or more components or performed by other components of equivalent functionality. In one instance, the GET monitoring platform 105 comprises data collection module 201, data preparation module 203, machine learning module 205, and user interface module 207, or any combination thereof.

In one instance, data collection module 201 may collect, in near real-time or in real-time, image data and/or video data associated with machine 101 and/or GET 115. For example, the image data may include a thermal image, stereoscopic image, etc. of the damaged, worn, and/or missing GET 115. In another instance, data collection module 201 may collect, in near real-time or real-time, motion data (e.g., force and/or movement) associated with machine 101. In a further instance, data collection module 201 may collect, in near real-time or real-time, weather data (e.g., heavy rain, heavy fog, heavy snow, dust, or any other environmental conditions) associated with worksite 111. In another instance, data collection module 201 may collect, in near real-time or in real-time, location data of machine 101 (e.g., a position of the machine within worksite 111). In another instance, data collection module 201 may collect, in near real-time or in real-time, any other relevant data (e.g., measurement data of GET 115, maintenance data of GET 115, etc.). Data collection module 201 may collect these data through various data collection techniques. For example, data collection module 201 may be in communication with sensors 103, and for additional data may use a web-crawling component to access various databases or other information sources to collect relevant data associated with machine 101, worksite 111, and/or GET 115. In another instance, data collection module 201 may include various software applications, e.g., data mining applications in Extended Meta Language (XML), that automatically search for and return relevant data regarding machine 101, worksite 111, and/or GET 115.

In one instance, data preparation module 203 may parse and arrange the data collected by data collection module 201. For example, data preparation module 203 may examine the collected data for any errors to eliminate bad data, e.g., redundant, incomplete, or incorrect data, to create high-quality data. The collected data, e.g., raw data, may be converted into a common format, e.g., machine-readable form, that is easily processed by other modules and platforms.

In one instance, machine learning module 205 may be a supervised machine learning that receives training data, e.g., training data 312 illustrated in the training flow chart 300, for training a machine learning model configured to determine a damage, wear, and/or loss condition of a GET. Machine learning module 205 may perform model training using training data, e.g., data from other modules, that contains input and correct output, to allow the model to learn over time. It should be understood that in some instances, training may occur prior to the deep learning networks being provided to the machine learning module 205. In other words, in some instances the deep learning networks may be pre-trained. In some instances, the deep learning networks may be trained using training data associated with the machine 101, with training machines of a similar type, and/or via simulation of a machine. The training is performed based on the deviation of a processed result from a documented result when the inputs are fed into the machine learning model, e.g., an algorithm measures its accuracy through the loss function, adjusting until the error has been sufficiently minimized. In one instance, machine learning module 205 may randomize the ordering of the training data, visualize the training data to identify relevant relationships between different variables, identify any data imbalances, and split the training data into two parts where one part is for training a model and the other part is for validating the trained model, de-duplicating, normalizing, correcting errors in the training data, and so on.

In one instance, machine learning module 205 may receive, as inputs, one or more visual data, motion data, weather data, location data, measurement data, and maintenance data, from sensors 103 associated with machine 101 and/or worksite 111. In one instance, machine learning module 205 may process the motion data to determine one or more tasks performed by machine 101, e.g., some tasks may have a relatively higher probability of damaging, wearing, and/or losing GET 115. In another instance, machine learning module 205 may process the weather data to determine one or more deep learning networks utilizing a different combination of sensor 103 as inputs for wear and/or loss estimation for GET 115. In another instance, machine learning module 205 may process the location data to identify the location of machine 101 when a missing GET 115 is partially or entirely separated from implement 113. Machine learning module 205 may also use historical location data to identify prior locations at which GET 115 may have become damaged or lost. Machine learning module 205 is discussed in further detail below.

In one instance, user interface module 207 may enable a presentation of a graphical user interface (GUI) in UE 107. User interface module 207 may employ various application programming interfaces (APIs) or other function calls corresponding to the application on UE 107, thus enabling the display of graphics primitives such as icons, bar graphs, menus, buttons, data entry fields, etc. In one instance, user interface module 207 may cause interfacing of guidance information to include, at least in part, one or more images, annotations, audio messages, video messages, or a combination thereof pertaining to the wear and/or loss of GET 115. For example, user interface module 207 may present an audio/visual notification in the interface of UE 107 upon determining GET 115 is worn, lost, or damaged (e.g., GET 115 is fractured and does not meet an operating criterion or threshold). For example, user interface module 207 may also generate a recommendation in the interface of UE 107 advising the user to replace the lost or damaged GET 115 with a new GET. For example, user interface module 207 may also generate a presentation of one or more images of GET 115 with a bounding box and instance segmentation of one or more objects within the bounding box (as depicted in UE 107 of FIG. 1).

The above presented modules and components of GET monitoring platform 105 may be implemented in hardware, firmware, software, or a combination thereof. Though depicted as a separate entity in FIG. 2, it is contemplated that the GET monitoring platform 105 may also be implemented for direct operation by respective machine 101 and/or UE 107. As such, the GET monitoring platform 105 may generate direct signal inputs by way of the operating system of machine 101 and/or UE 107. In another instance, one or more of the modules 201-207 are implemented for operation by the respective UEs, as the GET monitoring platform 105. The various executions presented herein contemplate any and all arrangements and models.

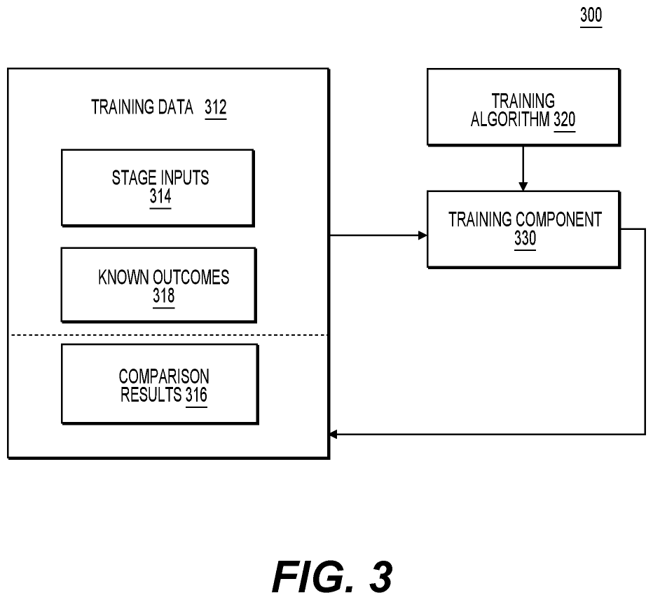

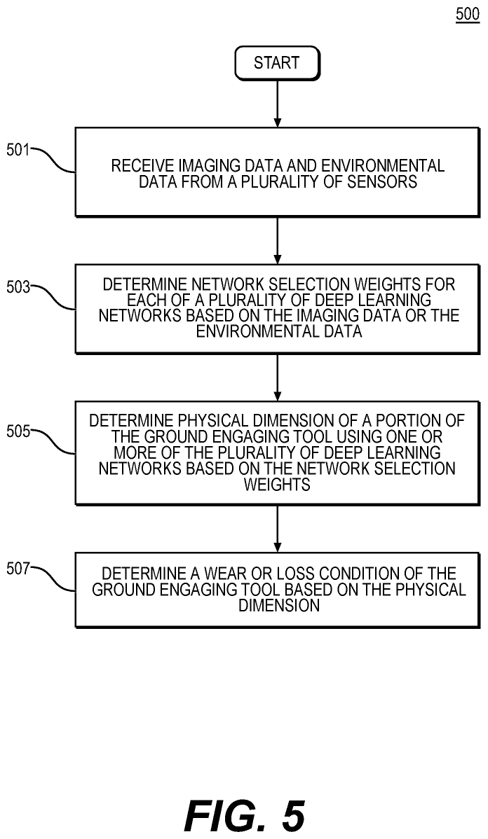

One or more implementations disclosed herein include and/or are implemented using a machine learning model. For example, one or more of the modules of the GET monitoring platform 105 are implemented using a machine learning model and/or are used to train the machine learning model. A given machine learning model is trained using the training flow chart 300 of FIG. 3. Training data 312 includes one or more of stage inputs 314 and known outcomes 318 related to the machine learning model to be trained. Stage inputs 314 are from any applicable source including text, visual representations, data, values, comparisons, and stage outputs, e.g., one or more outputs from one or more steps from FIG. 5. The known outcomes 318 are included for the machine learning models generated based on supervised or semi-supervised training. An unsupervised machine learning model may not be trained using known outcomes 318. Known outcomes 318 includes known or desired outputs for future inputs similar to or in the same category as stage inputs 314 that do not have corresponding known outputs.

The training data 312 and a training algorithm 320, e.g., one or more of the modules implemented using the machine learning model and/or are used to train the machine learning model, is provided to a training component 330 that applies the training data 312 to the training algorithm 320 to generate the machine learning model. According to an implementation, the training component 330 is provided comparison results 316 that compare a previous output of the corresponding machine learning model to apply the previous result to re-train the machine learning model. The comparison results 316 are used by training component 330 to update the corresponding machine learning model. The training algorithm 320 utilizes machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like. The machine learning model used herein is trained and/or used by adjusting one or more weights and/or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

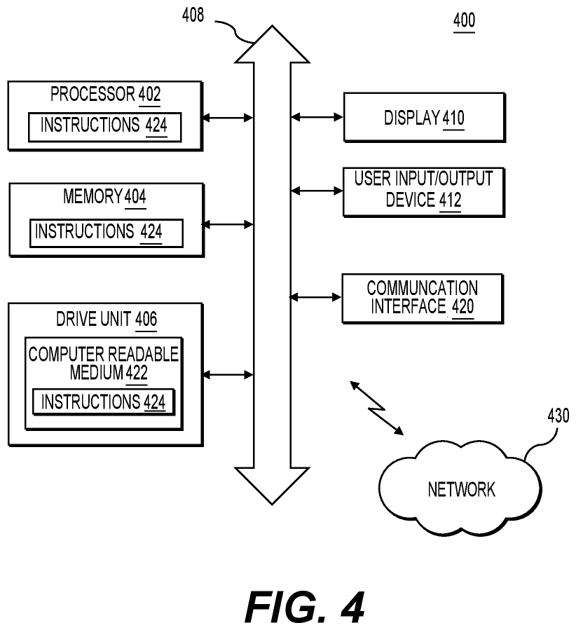

In various embodiments, one or more portions of the methods or techniques disclosed herein may be implemented in, for instance, a chip set including a processor and a memory as shown in FIG. 4. FIG. 4 illustrates an implementation of a general computer system that may execute techniques presented herein. The computer system 400 can include a set of instructions that can be executed to cause the computer system 400 to perform any one or more of the methods, system, or computer based functions disclosed herein. The computer system 400 may operate as a standalone device or may be connected, e.g., using a network, to other computer systems or peripheral devices.

In a networked deployment, the computer system 400 may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a personal trusted device, a web appliance, a network router, switch or bridge, or any other machine capable of executing a set of instructions (sequential or otherwise) that specify actions to be taken by that machine. In a particular implementation, the computer system 400 can be implemented using electronic devices that provide voice, video, or data communication. Further, while a computer system 400 is illustrated as a single system, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the computer system 400 may include an input/output device 412 configured to allow a user to interact with any of the components of computer system 400. The input/output device 412 may be a number pad, a keyboard, or a cursor control device, such as a mouse, or a joystick, touch screen display, remote control, or any other device operative to interact with the computer system 400.

The computer system 400 may also or alternatively include drive unit 406 implemented as a disk or optical drive. The drive unit 406 may include a computer-readable medium 422 in which one or more sets of instructions 424, e.g. software, can be embedded. Further, instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, a computer-readable medium 422 includes instructions 424 or receives and executes instructions 424 responsive to a propagated signal so that a device connected to a network 430 can communicate voice, video, audio, images, or any other data over the network 430. Further, the instructions 424 may be transmitted or received over the network 430 via a communication port or interface 420, and/or using a bus 408. The communication port or interface 420 may be a part of the processor 402 or may be a separate component. The communication port or interface 420 may be created in software or may be a physical connection in hardware. The communication port or interface 420 may be configured to connect with a network 430, external media, the display 410, or any other components in computer system 400, or combinations thereof. The connection with the network 430 may be a physical connection, such as a wired Ethernet connection or may be established wirelessly as discussed below. Likewise, the additional connections with other components of the computer system 400 may be physical connections or may be established wirelessly. The network 430 may alternatively be directly connected to a bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 400 may be connected to a network 430. The network 430 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 430 may include wide area networks (WAN), such as the Internet, local area networks (LAN), campus area networks, metropolitan area networks, a direct connection such as through a Universal Serial Bus (USB) port, or any other networks that may allow for data communication. The network 430 may be configured to couple one computing device to another computing device to enable communication of data between the devices. The network 430 may generally be enabled to employ any form of machine-readable media for communicating information from one device to another. The network 430 may include communication methods by which information may travel between computing devices. The network 430 may be divided into sub-networks. The sub-networks may allow access to all of the other components connected thereto or the sub-networks may restrict access between the components. The network 430 may be regarded as a public or private network connection and may include, for example, a virtual private network or an encryption or other security mechanism employed over the public Internet, or the like.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

### INDUSTRIAL APPLICABILITY

The disclosed methods and systems may be useful in various environments in which GETs may get damaged, worn, or become separated from a machine, including mining environments, construction environments, paving environments, forestry environments, and others. The disclosed methods and systems may be useful for various types of machines in these environments, e.g., digging machines (excavators, backhoes, dozers, drilling machines, trenchers, draglines, etc.), loading machines (wheeled or tracked loader, a front shovel, an excavator, a cable shovel, a stack reclaimer, etc.), hauling machines (articulated truck, an off-highway truck, an on-highway dump truck, a wheel tractor scraper, etc.), or any other machines suitable for a particular environment. Further, the disclosed methods and systems may be useful in scenarios where environmental conditions may impact the usability of sensors, and/or where environmental conditions are subject to change.

FIG. 5 is a flowchart of process 500 for determining wear and/or loss condition of a GET, according to some aspects of the disclosure. In various embodiments, GET monitoring platform 105 and/or any of the modules 201-207 may perform one or more portions of the process 500 and are implemented using, for instance, a chip set including a processor and a memory as shown in FIG. 4. As such, GET monitoring platform 105 and/or any of modules 201-207 may provide means for accomplishing various parts of process 500, as well as means for accomplishing embodiments of other processes described herein in conjunction with other components of system 100. Although process 500 is illustrated and described as a sequence of steps, it is contemplated that various embodiments of process 500 may be performed in any order or combination and need not include all of the illustrated steps. Further, process may be performed iteratively, continuously, or repeated on request, e.g., in response to changing environmental conditions.

In step 501, GET monitoring platform 105 may receive, via processor 402 utilizing sensor 103, data associated with machine 101 and/or worksite 111. In one instance, the data includes imaging data from imaging sensors of different modalities, such as a visible color (RGB) imager, a stereo camera, and/or a longwave infrared camera. In another instance, the data includes environmental conditions during a task at a worksite (e.g., worksite 111) and/or characteristic data for materials in the worksite from weather sensors of different modalities, temperature sensors, and/or ultrasonic sensors. The characteristic data for the materials include material type information, material density information, material texture information, material hardness information, material weight information, and/or moisture content of the material. In a further instance, data from sensor 103 may include operating condition of GET 115 (e.g., usage data, maintenance data, measurement data, and/or wear data).

In step 503, GET monitoring platform 105 may determine, via processor 402, network selection weights for each of a plurality of deep learning networks based on the received imaging data and/or the environmental data. In one instance, the plurality of deep learning networks includes a respective CNN. Each of the plurality of deep learning networks may utilize a different respective combination of sensor 103 (e.g., imaging sensors) as inputs. In one instance, GET monitoring platform 105 may weigh one deep learning network over another based on environmental conditions. For example, during heavy snow and rain conditions, GET monitoring platform 105 may give more weight to a deep learning network using an IR imaging sensor as opposed to a deep learning network using an RGB imaging sensor. Alternatively, GET monitoring platform 105 may utilize only one deep learning network from the plurality of deep learning networks to determine the wear and/or loss of at least one portion of GET 115 for a particular environmental condition. Such selection of only one deep learning network may not include network selection weights.

In step 505, GET monitoring platform 105 may determine, via processor 402, the physical dimension of a portion of GET 115 using one or more of the plurality of deep learning networks based on the network selection weights. In one instance, GET monitoring platform 105 may apply the network selection weights to object identification probability scores of the plurality of deep learning networks. The object identification probability scores indicate the confidence level of the detection of one or more objects. The GET monitoring platform 105 may generate a composite object identification that is based on a weighted combination of the object identification probability scores based on the network selection weights. The GET monitoring platform 105 may determine the physical dimension based on the composite object identification. In one instance, the physical dimension of a portion of GET 115 is based on a measurement of an instance segmentation based on the composite object identification. In one instance, the composite object identification is based on a weighted average of the detections of one or more objects by the plurality of deep learning networks weighted by the object identification probability scores and the network selection weights. In one instance, GET monitoring platform 105 may perform a normalization of the object identification probability score.

In one instance, GET monitoring platform 105 may utilize a plurality of deep learning networks to process at least one image of GET 115 to determine a bounding box for at least one region of interest. The GET monitoring platform 105 may utilize the plurality of deep learning networks to perform an instance segmentation of at least one image to detect, segment, and/or classify one or more objects within the bounding box. The instance segmentation may be utilized to determine the object identification probability score. In one instance, a comparison of a nominal physical dimension to the physical dimension is indicative of the wear or loss rate of GET 115. In one instance, each of the plurality of deep learning networks may identify a region of interest in at least one image associated with GET 115. Each of the plurality of deep learning networks may perform an instance segmentation of the at least one image with a confidence level. For example, deep learning network A may identify a portion of GET 115 with 90% confidence, whereas deep learning network B may identify the same portion of GET 115 with 70% confidence. The GET monitoring platform 105 may apply the network selection weights to deep learning networks A and B (e.g., network B may be weighed over network A based on environmental data, and a weight of 0.7 is applied to network B whilst a weight of 0.3 is applied to network A). GET monitoring platform 105 may calculate a weighted average for the location of the GET 115 to find a composite location.

In step 507, GET monitoring platform 105 may determine, via processor 402, wear or loss condition of GET 115 based on the physical dimension. For example, GET monitoring platform 105 may generate a notification in the user interface of UE 107 regarding the operable condition of GET 115 based, at least in part, on the physical dimension of GET 115. In one instance, GET monitoring platform 105 may compare the physical dimension and the operating condition of GET 115 to a pre-determined safety threshold associated with operating conditions, the predetermined safety threshold may include a minimum thickness threshold and/or a minimum wear percentage threshold. The GET monitoring platform 105 may generate a notification in the user interface of UE 107 based on the comparison, e.g., the notification may indicate GET 115 is not in an operable condition because the physical dimension and/or the operating condition of GET 115 is below the pre-determined safety threshold, the minimum thickness threshold and/or the minimum wear percentage threshold. In one instance, GET monitoring platform 105 may suspend the operation or cause one or more desired actions to be taken for machine 101 associated with a worn or missing GET 115, including machines other than machine 101 associated with the missing GET 115.

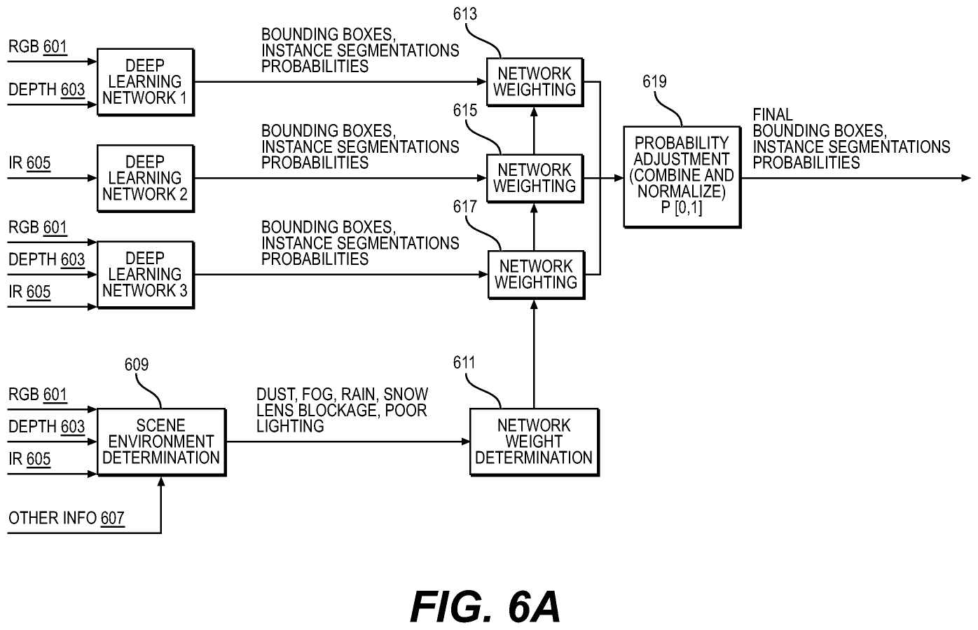

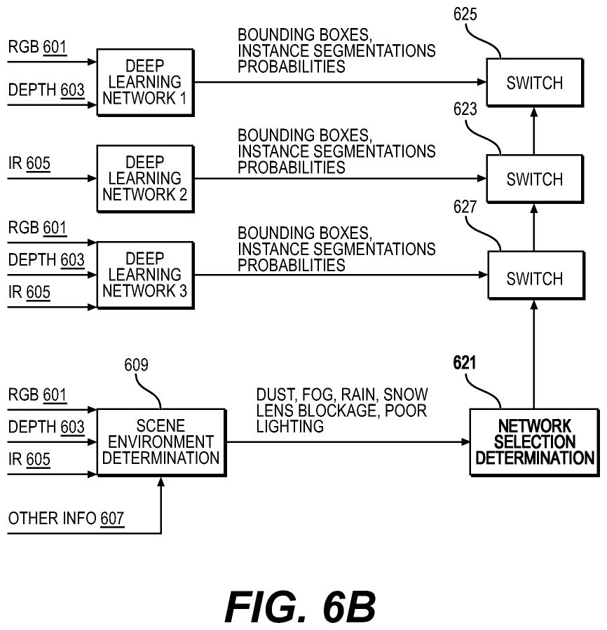

FIG. 6A illustrates a network schematic for combining a plurality of deep learning networks that fuses various sensors of different modalities to determine wear and/or loss condition of a GET, according to some aspects of the disclosure. Generally, sensor 103 of different modalities may be utilized for monitoring wear and/or loss of GET 115. For example, visible color (RGB) imager 601, stereo camera (depth) 603, and long-wave infrared (IR) camera 605 may be used, but these sensors have various strengths and weaknesses. Trained deep learning networks are required to obtain the best estimation of GET loss, breakage, and/or wear from these sensors.

In one instance, GET monitoring platform 105 may receive image data associated with GET 115 of machine 101 operating at worksite 111 from sensor 103 (e.g., visible color (RGB) imager 601, stereo camera (depth) 603, and long-wave infrared (IR) camera 605). The GET monitoring platform 105 may receive environmental data 607 associated with worksite 111 from sensor 103 (e.g., various weather sensors indicating the intensity of dust, wind, fog, rain, snow, lens blockage, natural lighting, etc. in the environment). The GET monitoring platform 105 may also receive other relevant data 607 on GET 115 (e.g., usage data, maintenance data, and/or measurement data indicating the operating condition of GET 115) from sensor 103 (e.g., various measurement sensors that evaluate GET 115).

In one instance, GET monitoring platform 105 may combine sensor 103 of different modalities during scene environmental determination 609. For example, GET monitoring platform 105 may predict heavy snow and low lighting based on the environmental data, since visible color (RGB) imager 601 and stereo camera (depth) 603 may not perform well during low visibility and poor lighting, long-wave infrared (IR) camera 605 may be used for determining wear, damage, and/or loss of GET 115. For example, GET monitoring platform 105 may estimate good weather conditions with good visibility and lighting based on the environmental data, and may fuse visible color (RGB) imager 601 and stereo camera (depth) 603 for capturing unblemished images of GET 115 for determining wear, damage, and/or loss of GET 115. For example, GET monitoring platform 105 may predict saturation or poor contrast in the environment based on the environmental data, since long-wave infrared (IR) camera 605 may not perform well during such environmental conditions, visible color (RGB) imager 601 and stereo camera (depth) 603 may be fused for determining wear, damage, and/or loss of GET 115.

In one instance, GET monitoring platform 105 may determine network selection weights (e.g., network weight determination 611) for each of a plurality of deep learning networks utilizing a different combination of the sensors as inputs. In one instance, deep learning network 1 may utilize visible color (RGB) imager 601 and stereo camera (depth) 603, deep learning network 2 may utilize long-wave infrared (IR) camera 605, and deep learning network 3 may utilize visible color (RGB) imager 601, stereo camera (depth) 603, and long-wave infrared (IR) camera 605.

In one instance, GET monitoring platform 105 may utilize deep learning networks 1, 2, and 3 to process sensor data (e.g., image data of GET 115) to determine at least one bounding box for a region of interest (ROI). The GET monitoring platform 105 may utilize deep learning networks 1, 2, and 3 to perform instance segmentation of the images to detect, segment, and/or classify one or more objects within the bounding box. The GET monitoring platform 105 may utilize deep learning networks 1, 2, and 3 to generate object identification probability scores indicative of a confidence level of the detection of one or more objects. In one instance, a deep learning network may have a higher object identification probability score based, at least in part, on the instance segmentation identifying a higher wear rate of GET 115 or a loss of GET 115.

In one instance, GET monitoring platform 105 may apply the network selection weights to the object identification probability score of each of the plurality of deep learning networks (network weightings 613, 615, and 617). The GET monitoring platform 105 may generate composite object identification based on the weighted combination of the object identification probability scores based on the network selection weights. The GET monitoring platform 105 may apply an adjustment to the composite object identification (e.g., normalization of the object identification probability score 619) to determine the physical dimension of GET 115 based on the composite object identification. The combination of the probabilities and proximities of the bounding boxes and instance segmentations may lead to a high probability prediction of wear and/or loss of GET 115.

FIG. 6B illustrates a network schematic for selecting only one deep learning network from the plurality of deep learning networks to determine wear and/or loss condition of a GET, according to some aspects of the disclosure. In one instance, GET monitoring platform 105 may predict heavy snow and low lighting based on the environmental data, and may determine to use only deep learning network 2 because long-wave infrared (IR) camera 605 may work better in such weather conditions than visible color (RGB) imager 601 and stereo camera (depth) 603 (network selection determination 621). In this example, GET monitoring platform 105 may turn on switch 623 of deep learning network 2, whereas switches 625 and 627 of deep learning networks 1 and 3, respectively, are turned off. The GET monitoring platform 105 may only utilize deep learning network 2 and the data from long-wave infrared (IR) camera 605 to determine the wear and/or loss of GET 115.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. It is intended that the specification and examples be considered as exemplary only, with a true scope of the disclosure being indicated by the following claims and their equivalents. Accordingly, the disclosure is not to be restricted except in the light of the attached claims and their equivalents.

What is claimed is:

1. A computer-implemented method for determining a wear or loss condition of a ground engaging tool, comprising:
receiving, by one or more processors, imaging data and environmental data from a plurality of sensors, wherein the plurality of sensors includes a plurality of imaging sensors of different modalities;
determining, by the one or more processors, network selection weights for each of a plurality of deep learning networks based, at least in part, on one or more of the imaging data or the environmental data, wherein each of the plurality of deep learning networks utilizes a different respective combination of one or more of the plurality of imaging sensors as inputs;
determining, by the one or more processors, at least one physical dimension of at least one portion of the ground engaging tool using one or more of the plurality of deep learning networks based on the network selection weights; and
determining, by the one or more processors, the wear or loss condition of the ground engaging tool based on the at least one physical dimension.

2. The computer-implemented method of claim 1, wherein the determining of the at least one physical dimension includes:
applying, by the one or more processors, the network selection weights to object identification probability scores of the plurality of deep learning networks;
generating, by the one or more processors, a composite object identification, wherein the composite object identification is based on a weighted combination of the object identification probability scores based on the network selection weights; and
determining, by the one or more processors, the at least one physical dimension based on the composite object identification.

3. The computer-implemented method of claim 2, wherein each of the plurality of deep learning networks is configured to determine the object identification probability scores by:
processing, by the one or more processors, at least one image of the ground engaging tool to determine at least one bounding box for at least one region of interest; and
performing, by the one or more processors, instance segmentation of the at least one region of interest to detect one or more objects within the at least one bounding box, wherein the object identification probability scores is indicative of a confidence level of the detection of the one or more objects.

4. The computer-implemented method of claim 3, wherein the composite object identification is based on a weighted average of the detections of the one or more object by the plurality of deep learning networks weighted by the object identification probability scores and the network selection weights, and wherein the at least one physical dimension of the at least one portion of the ground engaging tool is based on a measurement of the instance segmentation based on the composite object identification.

5. The computer-implemented method of claim 3, wherein a comparison of at least one nominal physical dimension to the at least one physical dimension is indicative of wear or loss rate of the ground engaging tool.

6. The computer-implemented method of claim 2, wherein an adjustment to the composite object identification includes:
performing, by the one or more processors, a normalization of the object identification probability scores.

7. The computer-implemented method of claim 1, wherein only one deep learning network from the plurality of deep learning networks is utilized to determine the at least one physical dimension of the at least one portion of the ground engaging tool.

8. The computer-implemented method of claim 2, further comprising:
receiving, by the one or more processors and from the plurality of sensors, data indicative of one or more operating condition of the ground engaging tool, wherein the one or more operating condition includes one or more of usage data, maintenance data, measurement data, or wear data; and
comparing, by the one or more processors, the at least one physical dimension to a predetermined safety threshold associated with the one or more operating condition, the predetermined safety threshold including a minimum thickness threshold, a minimum wear percentage threshold, or a combination thereof.

9. The computer-implemented method of claim 8, further comprising:
generating, by the one or more processors, a notification regarding operable conditions of the at least one ground engaging tool in a user interface of a user device based, at least in part, on the at least one physical dimension of the ground engaging tool.

10. The computer-implemented method of claim 1, wherein the plurality of imaging sensors include a visible color (RGB) imager, a stereo camera, and a longwave infrared camera.

11. The computer-implemented method of claim 1, wherein the plurality of sensors include one or more of a weather sensor, a temperature sensor, or an ultrasonic sensors that indicate one or more of an environmental condition at a worksite or characteristic data for materials in the worksite.

12. The computer-implemented method of claim 11, wherein the characteristic data for the materials include one or more of material type information, material density information, material texture information, material hardness information, material weight information, or moisture content of the material.

13. The computer-implemented method of claim 1, wherein each of the plurality of deep learning networks includes a respective convolutional neural network (CNN).

14. A system for determining a wear or loss condition of a ground engaging tool, comprising:
one or more processors; and
at least one non-transitory computer readable medium storing instructions which, when executed by the one or more processors, cause the one or more processors to perform operations comprising:
receiving imaging data and environmental data from a plurality of sensors, wherein the plurality of sensors includes a plurality of imaging sensors of different modalities;
determining network selection weights for each of a plurality of deep learning networks based, at least in part, on one or more of the imaging data or the environmental data, wherein each of the plurality of deep learning networks utilizes a different respective combination of one or more of the plurality of imaging sensors as inputs;
determining at least one physical dimension of at least one portion of the ground engaging tool using one or more of the plurality of deep learning networks based on the network selection weights; and
determining the wear or loss condition of the ground engaging tool based on the at least one physical dimension.

15. The system of claim 14, wherein the determining of the at least one physical dimension includes:
applying the network selection weights to object identification probability scores of the plurality of deep learning networks;
generating a composite object identification, wherein the composite object identification is based on a weighted combination of the object identification probability scores based on the network selection weights; and
determining the at least one physical dimension based on the composite object identification.

16. The system of claim 15, wherein each of the plurality of deep learning networks is configured to determine an object identification probability score by:
processing at least one image of the ground engaging tool to determine at least one bounding box for at least one region of interest; and
performing instance segmentation of the at least one region of interest to detect one or more objects within the at least one bounding box, wherein the object identification probability scores is indicative of a confidence level of the detection of the one or more objects.

17. The system of claim 16, wherein the composite object identification is based on a weighted average of the detections of the one or more object by the plurality of deep learning networks weighted by the object identification probability scores and the network selection weights, and wherein the at least one physical dimension of the at least one portion of the ground engaging tool is based on a measurement of the instance segmentation based on the composite object identification.

18. A non-transitory computer readable medium for determining a wear or loss condition of a ground engaging tool, the non-transitory computer readable medium storing instructions which, when executed by one or more processors, cause the one or more processors to perform operations comprising:
receiving imaging data and environmental data from a plurality of sensors, wherein the plurality of sensors includes a plurality of imaging sensors of different modalities;
determining network selection weights for each of a plurality of deep learning networks based, at least in part, on one or more of the imaging data or the environmental data, wherein each of the plurality of deep learning networks utilizes a different respective combination of one or more of the plurality of imaging sensors as inputs;
determining at least one physical dimension of at least one portion of the ground engaging tool using one or more of the plurality of deep learning networks based on the network selection weights; and
determining the wear or loss condition of the ground engaging tool based on the at least one physical dimension.

19. The non-transitory computer readable medium of claim 18, wherein the determining of the at least one physical dimension includes:
applying the network selection weights to object identification probability scores of the plurality of deep learning networks;
generating a composite object identification, wherein the composite object identification is based on a weighted combination of the object identification probability scores based on the network selection weights; and
determining the at least one physical dimension based on the composite object identification.

20. The non-transitory computer readable medium of claim 19, wherein each of the plurality of deep learning networks is configured to determine an object identification probability score by:
processing at least one image of the ground engaging tool to determine at least one bounding box for at least one region of interest; and
performing instance segmentation of the at least one region of interest to detect one or more objects within the at least one bounding box, wherein the object identification probability scores is indicative of a confidence level of the detection of the one or more objects.
